(19) United States
(12) Patent Application Publication
(10) Pub. No.: US 2026/0100120 A1
(43) Pub. Date: Apr. 9, 2026

(54) ATTIC FIRE DETECTION SYSTEM

(71) Applicant: LINDSEY FIRESENSE, LLC, Azusa, CA (US)

(72) Inventors: Jagdishbhai U. Patel, Granada Hills, CA (US); Keith E. Lindsey, La Cañada Flintridge, CA (US); John McCall, Rancho Cucamonga, CA (US)

(21) Appl. No.: 19/351,165

(22) Filed: Oct. 6, 2025

Related U.S. Application Data
(60) Provisional application No. 63/703,870, filed on Oct. 4, 2024.

(51) Int. Cl. G08B 17/12

(52) U.S. Cl. CPC G08B 17/125

(57) ABSTRACT

An enclosed spaces fire detection system is provided. An enclosed spaces fire detection system includes a housing configured to be mounted in an enclosed space, such as an attic, a garage, a kitchen, or a laundry room; and at least one infrared imaging camera supported by the housing and including a thermopile focal plane array (FPA) with an antireflective layer on a thermopile lens configured to pass infrared radiance in a first range corresponding to a fire in the enclosed space.

### BACKGROUND

### 1. Field

Aspects of embodiments of the present invention relate to an attic and similar enclosed spaces fire detection system.

### 2. Description of the Related Art

Rapid detection of fires occurring in unattended and out of sight attic and similar enclosed spaces, is direly needed. Attic fires are known as the most destructive to homes and personal possessions, due to late detection in lieu of prompt detection technology. Attic fires are also proven to be the most challenging fires to extinguish. These fires can be extremely dangerous because the true conditions are hidden in the attic spaces, and firefighters may not be expecting a sudden change in conditions when an attic flashover occurs. According to the U.S. FEMA, there are over 10,000 attic fires each year in the U.S., resulting in an average of 35 deaths, 125 injuries, and $440 million in property damage. While newly updated building codes and flame-retardant building materials are expected to reduce these numbers, the total number of attic fires has not decreased over recent years.

A common cause of attic fires is heating. Roughly 5% of residential attic fires are caused by home heating systems. Buildup of dust, lint, and debris in ducts or around a furnace create the potential for a fire.

Conventional smoke detectors are not recommended for attics due to their upper operating limit of 105° F., while attic temperatures could be much higher than that. Currently available technologies for attic fire detection depend on slower detection methods and processes, such as temperature rise measurement, temperature threshold, and complicated flame detection, and fall short of meeting prompt detection and warning/reporting requirements. Some conventional fire detectors also sample air via pumping to detect fire signature, and suffer from severe limitations. Conventional fire detectors are unable to effectively detect fire in an attic and enclosed spaces, at the point of ignition and promptly.

For example, conventional thermal cameras are expensive, and utilize scanning for detection instead of continuous staring, thereby compromising accuracy and efficiency. Also, thermal imaging cameras have severe limitations of range of detection and associated accuracy, require periodic calibration due to exposure to heat sources and adjusting to maintain operability, and are susceptible to temperature variations and other environmental condition changes.

Flame detectors suffer from limited field of view and cover smaller surface area; hence, many such detectors are required in case of attic fire detection. Further, a drawback with flame detectors is the need for allowing a long time since the ignition of the fire in the attic until a flame takes shape to become detectable. Such a delay will make the fire detection too late to prevent damage and losses.

Further, a large number of home fires may occur in a kitchen, garage, or laundry room. It is estimated that 1.5 million fires occur in the U.S. each year from cooking and attic fires, resulting in 13,250 injuries and 3,790 civilian deaths caused by home fires.

Optical smoke alarms can be situated in bedrooms and living rooms and in a ground floor hallway. The optical technology makes the alarms less prone to false alarms from cooking fumes. However, optical or ionization smoke alarms may fail to operate in high temperatures over 110° F., such as in an attic, causing false alarms and failing detection of fires.

Other detectors may be plugged into electrical outlets to detect electrical fire hazards, but may not detect a fire in real-time to provide prompt fire detection and may actually cause fires.

The above information disclosed in this Background section is for enhancement of understanding of the background of the present disclosure, and, therefore, it may contain information that does not constitute prior art.

### SUMMARY

According to an aspect of one or more embodiments of the present disclosure, an enclosed spaces fire detection system, such as to be mounted in an attic, kitchen, garage, or laundry room, is provided.

According to another aspect of one or more embodiments of the present disclosure, an enclosed spaces fire detection system which promptly detects fires within moments of ignition, at the point of ignition before it spreads or explodes, is provided.

According to another aspect of one or more embodiments of the present disclosure, an enclosed spaces fire detection system which may eliminate false alarms, such as due to an HVAC system burner, oven, stove, or dryer, is provided.

According to another aspect of one or more embodiments of the present disclosure, an enclosed spaces fire detection system which may report a fire immediately via multiple modes of connectivity to occupants, home security monitors, and firefighters is provided.

According to another aspect of one or more embodiments of the present disclosure, an enclosed spaces fire detection system which may recognize a fire immediately, rather than based on a secondary effect (e.g., rate of the rise in temperature, high temperature or smoke) of a fire, is provided.

According to another aspect of one or more embodiments of the present disclosure, an enclosed spaces fire detection system including a thermopile (e.g., a silicon pixel thermopile) having high sensitivity and which does not require regular calibration, is provided.

According to one or more embodiments, an enclosed spaces fire detection system includes: a housing configured to be mounted in an attic and enclosed spaces; and at least one infrared imaging device supported by the housing and including a thermopile focal plane array (FPA) with an antireflective layer on a thermopile lens configured to pass infrared radiance in a first range corresponding to a fire in the attic and enclosed spaces.

In one or more embodiments, the at least one infrared imaging device includes a focal plane array (FPA) infrared camera.

In one or more embodiments, the antireflective layer is configured as a coating on the thermopile lens, which may customize the optics to preferably allow fire specific infrared radiation (e.g., about 4.25 μm) with enhanced transmission and suppress other infrared noise to enhance the sensitivity to fire detection.

In one or more embodiments, the enclosed spaces fire detection system includes four to eight thermopiles.

In one or more embodiments, each of the thermopiles has a field of view range of 90°×90°.

In one or more embodiments, the antireflective layer on the thermopile lens is configured to block infrared radiance in a second range different from the fire's characteristic radiance.

In one or more embodiments, the at least one infrared device includes a plurality of infrared imaging cameras arranged around a periphery of the housing so as to be configured to detect a fire at any of a plurality of sides of the enclosed spaces fire detection system.

In one or more embodiments, the enclosed spaces fire detection system further includes at least one visible fisheye lens camera configured to obtain an image of an area around the enclosed spaces fire detection system in response to an output from the at least one infrared imaging camera.

In one or more embodiments, the at least one infrared imaging device includes a plurality of infrared cameras arranged around a periphery of the housing so as to be configured to detect a fire at any of a plurality of sides of the enclosed spaces fire detection system, the at least one visible camera includes a plurality of cameras arranged around the periphery of the housing so as to be configured to obtain an image at any of the plurality of sides of the enclosed spaces fire detection system, and each of the plurality of infrared imaging cameras and the plurality of cameras is arranged as a fixed array

In one or more embodiments, a shape of the housing is adjustable to efficiently cover surfaces of attics with varying heights. In one or more embodiments, the housing is reconfigurable in height.

In one or more embodiments, the attic and enclosed spaces fire detection system is configured to transmit a signal to a user, await acknowledgment, and send another signal if acknowledgment is not received.

In one or more embodiments, the enclosed spaces fire detection system is configured to capture an image if heat is detected by the at least one infrared imaging camera.

According to some aspects of embodiments of the present invention, an enclosed spaces fire detection system utilizes real-time algorithms for on-board processing for positive detection, and offers prompt detection of a tiny heat source at the origin of the fire. Rapid detection of a fire in enclosed spaces, such as attics, allows one to extinguish it in time with very little effort, thereby avoiding catastrophic effects if not detected. Possible false alarms, such as from an attic-based HVAC system burner, an oven, a stove, a toaster over, or a dryer, may be filtered by a known location and seasonal calendar, such as winter or summer. A fire warning may be communicated via a multimode persistent real-time two-way communications with specified contacts until the fire warning is acknowledged within a shortest possible time. Further, on-the-spot detection of a fire (e.g., an attic fire) as soon as it starts while still very small, allows enough time to extinguish the fire before it gets out of control and causes damage and spreads to neighboring structures or homes. Further, an enclosed spaces fire detection system according to one or more embodiments of the present invention may communicate with firefighters and guide them to extinguish a fire, such as an attic fire, and the point of ignition while the fire is still small, and works in extreme environments over all seasons, in day and night, by continuously staring at all surfaces of the attic and enclosed spaces and taking heat images periodically and continuously analyzing the images for heat detection.

### BRIEF DESCRIPTION OF THE DRAWINGS

The above and other features and aspects will become more apparent to those of ordinary skill in the art by describing in further detail some example embodiments of the present invention with reference to the attached drawings, in which:

FIG. 1 shows bottom and side views of an enclosed spaces fire detection system according to some embodiments of the present invention;

FIGS. 2A and 2B show side views of an enclosed spaces fire detection system according to some embodiments of the present invention;

FIGS. 3 and 4 show an enclosed spaces fire detection system mounted under a roof (e.g., in an attic) according to some embodiments of the present invention;

FIG. 5 is a flowchart showing operation of an enclosed spaces fire detection system according to one or more embodiments of the present invention;

FIG. 6 is a flowchart showing an alarm and warning communication of an enclosed spaces fire detection system according to one or more embodiments of the present invention; and

FIG. 7 is a flowchart showing a thermopile data analysis code of an enclosed spaces fire detection system according to one or more embodiments of the present invention.

### DETAILED DESCRIPTION

Herein, some example embodiments will be described in further detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and, thus, descriptions thereof may not be repeated.

In the drawings, relative sizes of elements, layers, and regions may be exaggerated and/or simplified for clarity.

It is to be understood that, although the terms “first,” “second,” “third,” etc., may be used herein to describe various elements, components, regions, layers and/or sections, these elements, components, regions, layers, and/or sections are not limited by these terms. These terms are used to distinguish one element, component, region, layer or section from another element, component, region, layer, or section. Thus, a first element, component, region, layer, or section described below could be termed a second element, component, region, layer, or section, without departing from the spirit and scope of the present disclosure.

It is to be understood that when an element or layer is referred to as being “on,” “connected to,” or “coupled to” another element or layer, it may be directly on, connected to, or coupled to the other element or layer, or one or more intervening elements or layers may be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It is to be further understood that the terms “comprises,” “comprising,” “includes,” and “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which the present disclosure belongs. It is to be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Embodiments of the present invention provide an enclosed spaces fire detection system configured to detect a fire in enclosed spaces, such as an attic, garage, kitchen, or laundry room, during both day and night by the characteristic infrared (IR) radiance of the fire. Additionally, embodiments of the present invention are configured to detect such fires with improved sensitivity and accuracy by avoiding or reducing interference from warm or hot surrounding objects, such that small fires may be detected at a point of ignition, thereby allowing quick response time so that the fire can be extinguished while still small.

According to embodiments of the present invention, a system or device for detecting fires in enclosed spaces is provided using one or more low-cost imaging cameras so as to efficiently and accurately detect a fire.

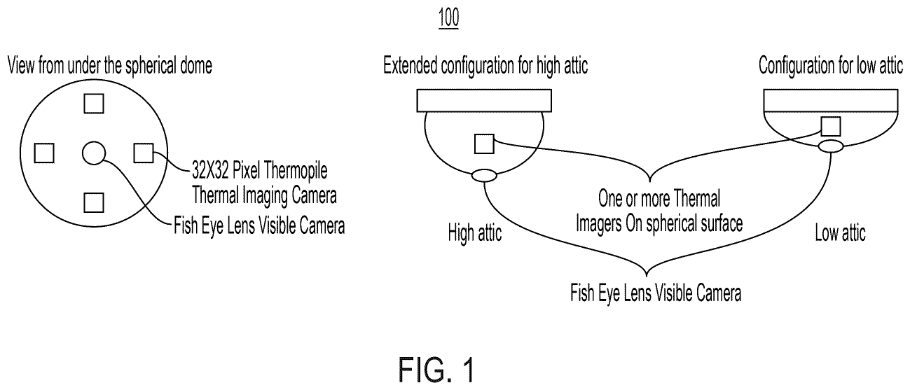

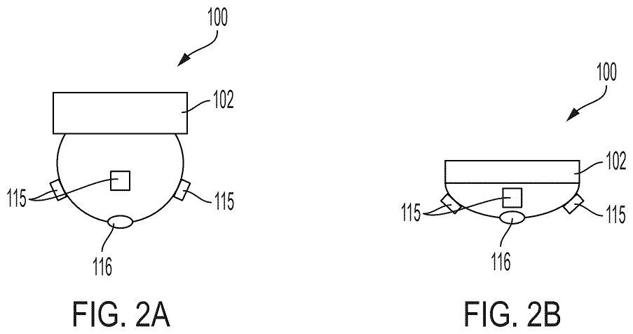

FIG. 1 shows bottom and side views of an enclosed spaces fire detection system according to some embodiments of the present invention; and FIGS. 2A and 2B show side views of an enclosed spaces fire detection system according to some embodiments of the present invention.

According to embodiments of the present invention, a thermoelectric effect is the principle of operation for a thermopile focal plane array IR camera, in contrast to other thermal imaging techniques. Silicon pixels of the thermopile imaging array generate a voltage signal as a result of the absorbed IR radiation by a pixel emanating from the heat sources. Pixels of the thermopile array do not degrade over time after prolonged exposures to heat sources, and hence do not shift in calibration, providing a very stable operation over long periods of time, unlike other thermal imaging cameras.

In one or more embodiments of the present invention, heat detection is accomplished by four to eight of 32×32-pixel thermopile imaging cameras mounted on a hemispherical housing at different heights to cover a wide range of an enclosed spaces or a height thereof (e.g., attic heights) forming varied surface sizes, as illustrated in FIG. 1. The thermopile imaging cameras may take thermal images of an entire enclosed space at programmable time intervals, looking for a very small source of heat at the instant the heat arises. In one or more embodiments, each of the thermopiles has a 90°×90° field of view (FOV) so as to cover all areas of the enclosed space. In one or more embodiments, a COTS thermopile camera modified by custom antireflecting (AR) coating on Si lens optics to enhance signal over noise is used. Once heat is detected by the thermal camera, a visual camera, such as a fisheye lens camera, may provide visual confirmation in order to avoid any false alarms.

In one or more embodiments, an enclosed spaces fire detection system 100 includes a thermopile focal plane array cameras for thermal imaging (e.g., four to eight), a visible camera (e.g., a fisheye lens camera) for visual verification, a microprocessor for data acquisition and processing, system control and operation firmware with Built-In Self-Test (BIST), data processing algorithms for IR and visible image data, a power supply with a rechargeable battery pack with extended operating life, a Wi-Fi communication system connected to home internet, cellular connectivity for transmitting warning signals as needed, and a warning communication algorithm and control. However, in one or more embodiments, one or more of the above-mentioned components may be omitted. Further, in one or more embodiments, the enclosed spaces fire detection system 100 may be hardwired or powered via an internet instead of, or in addition to, a rechargeable battery pack.

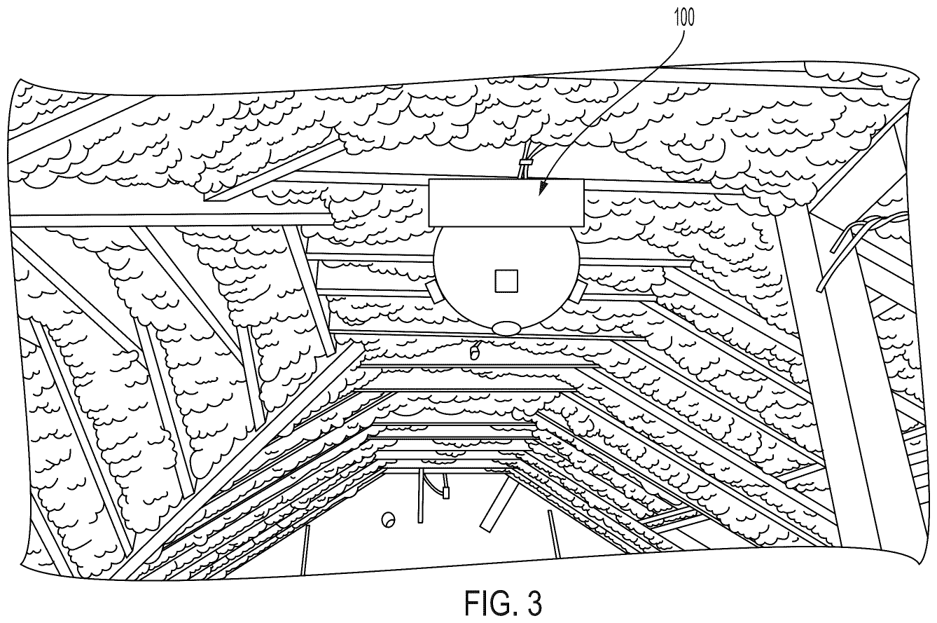

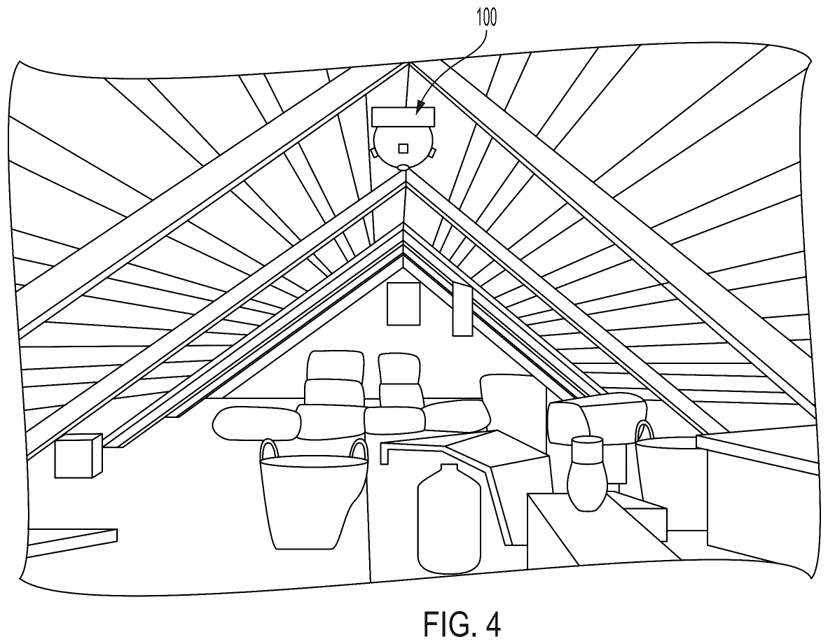

FIGS. 3 and 4 show an enclosed spaces fire detection system mounted under a roof (e.g., in an attic) according to some embodiments of the present invention.

In one or more embodiments, the enclosed spaces fire detection system 100 may include a housing 102 which is mountable on (e.g., directly mountable on) a structure, such as a roof or ceiling of an attic. In one embodiment, for example, the enclosed spaces fire detection system 100 may include one or more cameras 116, and one or more IR cameras (e.g., four to eight) IR cameras 115 to provide a wide range of coverage. The one or more cameras 116, for example, may be employed to provide confirmation of a fire after a signal from the IR cameras 115 has been received. However, in some embodiments, the one or more cameras 116 may be omitted.

In one or more embodiments, the enclosed spaces fire detection system 100 may include a processing circuit and may be part of an electronic communication system. In one or more embodiments, for example, computing may be performed by the processing circuit of the device 100, and the enclosed spaces fire detection system 100 may send out alarms in connection with results of the computing.

In one or more embodiments, the housing 102 may include an upper housing and a lower housing. In an embodiment, the lower housing may include a hemispherical portion. However, a configuration of the housing 102 is not limited thereto. The hemispherical portion may provide a mounting surface for devices (e.g., the IR detectors 115 and the one or more cameras 116) positioned to take measurements at different angles toward a surface below the enclosed spaces fire detection system 100. In an embodiment, a plurality of the IR detectors 115 is arranged around a perimeter of the hemispherical portion, such that the enclosed spaces fire detection system 100 may detect a fire at all sides. Further, the enclosed spaces fire detection system 100 may be a fixed (“staring”) type, rather than a scanning type, thereby providing improved absorption of heat flux and also reducing response time. In an embodiment, a plurality of the enclosed spaces fire detection systems 100 may be used in an enclosed space, such as in a warehouse or an attic having a discontinuous shape. In one or more embodiments, the housing 102 may be made of a suitable material that can be changed in shape, such as to allow a shape (e.g., a height) of the housing 102 to be varied, as shown in FIG. 1, for example, to be adjusted based on a size (e.g., a height) of an enclosed space, such as that of an attic. In an embodiment, for example, the shape of the housing 102 may be adjustable by a user, such as via a screw or other suitable device.

In one or more embodiments, the enclosed spaces fire detection system 100 may be used in an enclosed spaces, such as an attic, in which temperatures may be in a range of 120 to 230° F. Further, in one or more embodiments, a range of the thermopile may be about 100 meters; however, the present invention is not limited thereto.

According to one or more embodiments of the present invention, an enclosed spaces fire detection system includes an infrared camera for fire detection including an antireflective layer on both sides of a plano-convex lens of a thermopile and configured to pass infrared radiance in a first range corresponding to a fire and block infrared radiance in a second range. That is, by blocking the infrared radiance in the second range, interference or noise from surrounding hot objects (e.g., an HVAC system burner, an oven, a stove, a toaster oven, or a dryer) may be reduced, such that fires may be accurately and quickly detected without false alarms.

In one or more embodiments, the enclosed spaces fire detection system 100 may be integrated with a conventional smoke and/or carbon monoxide sensor (see, e.g., FIG. 2B). The IR detectors 115 may be oriented or angled to aim downward, and may have same or different angles so as to point to one or more heat sources, such as a stove and a toaster oven in a kitchen. A threshold temperature in the code may be set to 400 degrees Kelvin, for example, but may be adjusted to a certain (e.g., predetermined) temperature threshold or a threshold number of pixels. Also, a number of the IR detectors 115 may be varied, and be four or eight, for example,

In one or more embodiments, an antireflective (AR) coating on the lens is a diamond like coating (DLC) layer, which provides resistance to degradation due to environmental factors. For example, the DLC layer may be formed at high temperatures from a class of amorphous carbon material that displays some of the typical properties, such as hardness, of diamond. Further, the DLC layer may have a low friction coefficient and high wear resistance, so as to be resistant to abrasion, and may also be resistant to salts, acids, alkalis, and organic solvents. In an embodiment, the lens has a coating thickness of λ/4, which means that the anti-reflective DLC is applied at a thickness equal to ¼ of the median wavelength of the first range described herein. In an embodiment, each of the outer surface of the lens and the inner surface of the lens has an antireflective coating thickness of λ/4. Further, in an embodiment, the inner surface may have a coating comprised of multiple layers of Ge and ZnS or similar materials having a total thickness of λ/4.

In one or more embodiments, the system 100 includes one or more thermopile detectors as described in U.S. patent application Ser. No. 18/527,010, the entire disclosure of which is incorporated by reference herein.

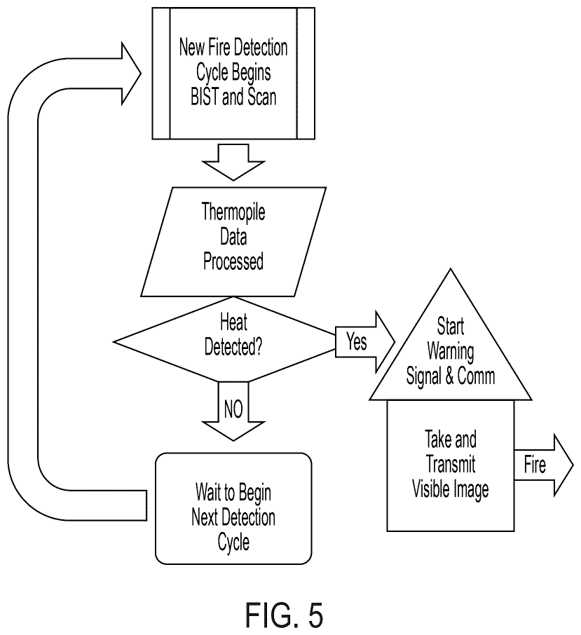

FIG. 5 is a flowchart showing operation of an enclosed spaces fire detection system according to one or more embodiments of the present invention.

In one or more embodiments, during each cycle of detection by the system, the system takes IR images sequentially from each thermopile and processes onboard each image immediately to detect a smallest heat source and its location in the enclosed space. False alarms, such as from an attic-based HVAC system burner may be avoided via processing algorithms. Once a heat source is detected, the camera (e.g., a fisheye lens camera) takes a visible image. Once the fire is confirmed, a local siren alarm may be triggered inside and outside the home or structure. A fire warning may be communicated along with fire location in the enclosed space via Wi-Fi and cellular networks either present inside the structure or away. An associated visual image from the camera (e.g., fisheye lens camera) may also delivered for confirmation. A user, such as a homeowner is expected to confirm the receipt of the alarm back to the device and take further action of extinguishing the small fire or call other resources to take such action. In case the device does not receive confirmation from the user, other parties may be informed sequentially, such that the fire department is the last to be informed. If there is no heat detection during the cycle, a next detection cycle may be started as programmed.

The system takes IR images of the covered whole attic and enclosed spaces area with multiple thermopile cameras in order to promptly detect a small heat source as soon as it ignites. Detection followed by onboard data analysis, data fusion for positive ID of a fire, a size of the fire, and an exact location of the fire in the enclosed space help to provide extinction measures during a critical time period. Such capability may eliminate a struggle for locating the fire. Each cycle may begin with a built-in self-test to make sure all system components are functioning according to specifications and within a tolerance range. Data generated and processed in real-time for fire prompt detection and confirmation.

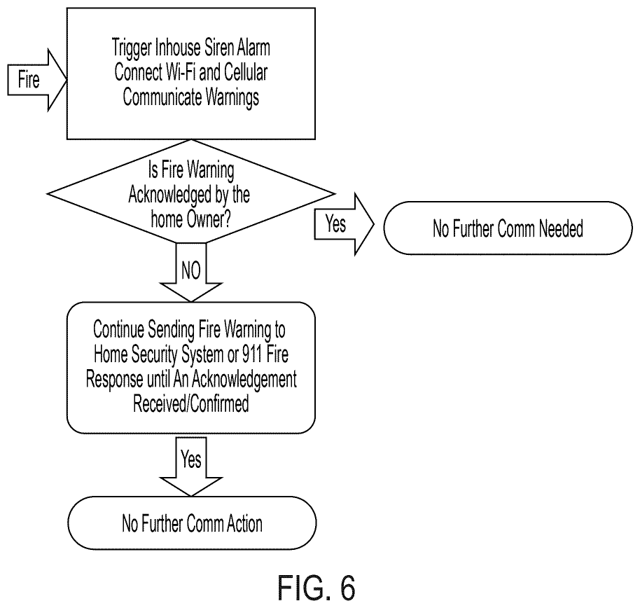

FIG. 6 is a flowchart showing an alarm and warning communication of an enclosed spaces fire detection system according to one or more embodiments of the present invention.

In one or more embodiments, as soon as a small fire is detected at a point of origin, alarms and warning communications begin immediately. In one or more embodiments, first, action trigger fire warning sirens inside and outside the house or structure, sirens continually sound until manually reset. A communication mode designed to be two-way, meaning that when a warning is sent to recipient, acknowledgement is also expected in order to close repeated communication attempts to the same recipient. An in-house siren alarm inside the house may be triggered first, followed by Wi-fi communication to all occupants on their call phones. Once an acknowledgement is received, warning communication stops. If no acknowledgement is received from the Wi-fi channel, cellular communication may be used to warn the occupants. If no acknowledgement is received at all, simultaneous warning may be communicated to a home security system or to a fire department and/or 911 system, with no acknowledgement required from those points. When communicated over multiple channels to many recipients, the system expects fire extinction taking place immediately to save the home or structure, personal belongings, life, injuries, etc.

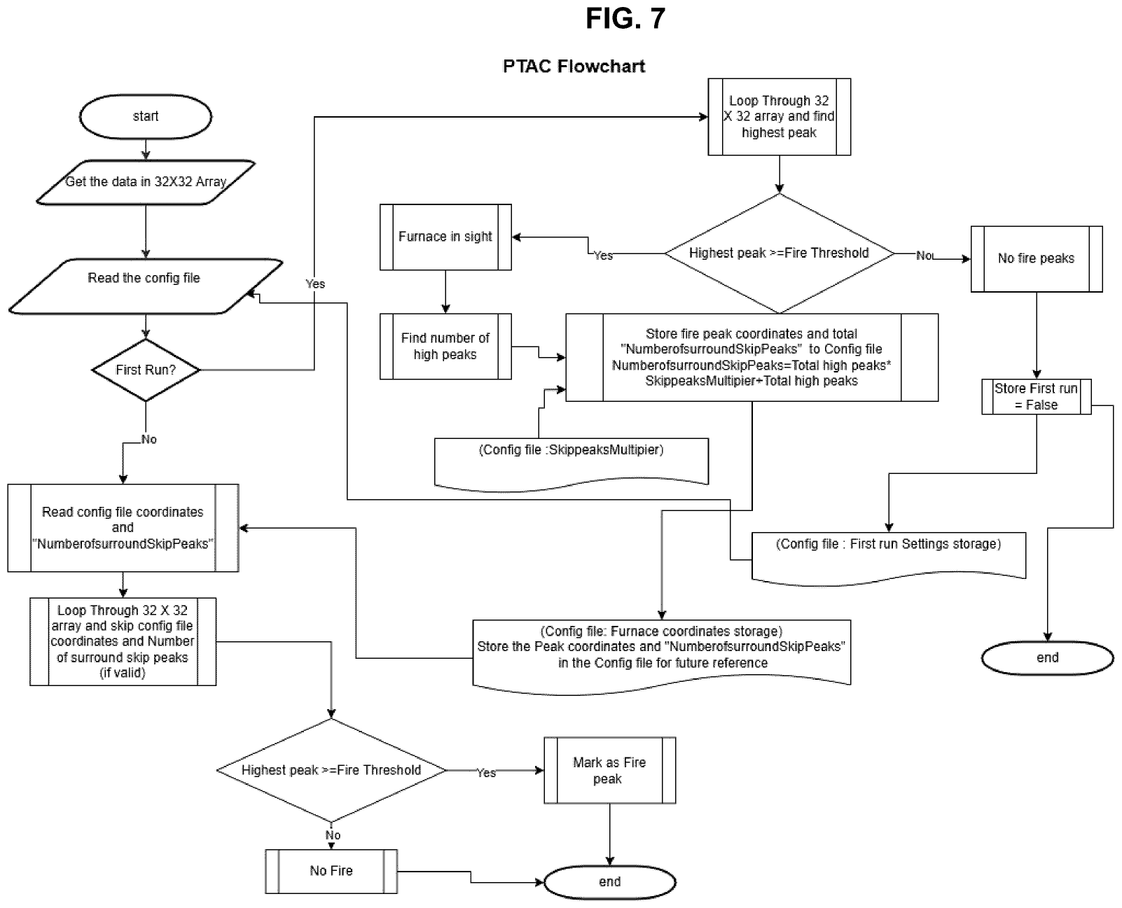

FIG. 7 is a flowchart showing a thermopile data analysis code of an enclosed spaces fire detection system according to one or more embodiments of the present invention.

According to one or more embodiments, thermopile data analysis code (PTAC) is configured to run on the fire detector (AFD), (e.g., the above-described enclosed spaces fire detection system), to promptly detect extremely small-sized, and/or just erupted hotspots/fires inside an attic, for example, from a variety of causes. Rapid detection of a fire in an attic, for example, allows one to extinguish it in time with very little effort, thereby avoiding catastrophic effects if not detected. PTAC may be run by the AFD firmware in two different modes to detect fires, and avoid any false alarms from an HVAC system furnace burner, for example, or other appliance heat source. A first mode will at the installation for the initialization and calibration run to detect the presence of the furnace burner in the view of a thermopile from its thermal signature while the HVAC or other appliance heat source is kept running. Once the thermopile that locates the burner is identified, a configuration file will be created which will allow the processing of all subsequent data from that particular thermopile data which will ignore only the footprint of the burner. Now, any fire erupting adjacent to the burner will still get detected. The rest of the thermopile will work in the normal mode. Thus, each thermopile will have its own instance of PTAC.

As described above, during the initial installation, when the thermopiles are calibrated, PTAC will run with the first run flag set to true. This process helps identify any furnace present in the enclosed space, such as an attic. If a thermopile detects a fire of a furnace during calibration, PTAC will capture those pixels and store them in the configuration file for future reference. Additionally, the first run flag will be set to false after calibration. For thermopiles that are not in direct sight of the furnace, this calibration will not store any pixels in the configuration file.

During normal operations, if PTAC detects that the first run flag is set to true in the configuration file, it will store any furnace fire footprint pixels and calculates NumberofSurroundSkipPeaks (Total Number of High Peaks*0.5) from the initial run, then save this information back into the PTAC configuration file. It will then set the first run flag to false.

In an embodiment, the PTAC will process the data in a 32×32 array from each thermopile for next cycles of iterations. During this process, it will skip all pixels associated with the furnace fire along with the NumberofSurroundSkipPeaks. It will then check the remaining pixels for any new fire. It will still successfully detect any fire next to the burner, such as a fire accidentally started adjacent to it by the burner malfunction. This operation will continue as long as the AFD remains installed in the same enclosed space, e.g., an attic, with the HVAC system or other appliance heat source still located in the same position and until a cold reset button is pressed at a next installation.

If the AFD is removed from its original location for any reason and reinstalled in a reoriented position or at a different location, a cold reset button will be pressed and it will be able to run the initialization mode again as described above. The PTAC on the AFD for the thermopile can be reset by setting the first-run flag to true. In an embodiment, a small code snippet can achieve this reset based on a hardware trigger.

Although some example embodiments have been described herein, those skilled in the art will readily appreciate that various modifications are possible in the example embodiments without departing from the spirit and scope of the present disclosure. It is to be understood that descriptions of features or aspects within each embodiment should typically be considered as available for other similar features or aspects in other embodiments, unless otherwise described. Therefore, it is to be understood that the foregoing is illustrative of various example embodiments and is not to be construed as limited to the specific example embodiments disclosed herein, and that various modifications to the disclosed example embodiments, as well as other example embodiments, are intended to be included within the spirit and scope of the present disclosure as set forth in the appended claims, and their equivalents.

What is claimed is:

1. An enclosed spaces fire detection system comprising:
a housing configured to be mounted in an enclosed space; and
at least one infrared imaging device supported by the housing and comprising a thermopile focal plane array (FPA) with an antireflective layer on a thermopile lens configured to pass infrared radiance in a first range corresponding to a fire in the enclosed space.

2. The enclosed spaces fire detection system of claim 1, wherein the at least one infrared imaging device comprises a focal plane array (FPA) infrared camera with lens coated with custom antireflective (AR) layers coatings.

3. The enclosed spaces fire detection system of claim 1, wherein the antireflective layer is configured as a coating on the thermopile lens.

4. The enclosed spaces fire detection system of claim 1, wherein the enclosed spaces fire detection system includes four to eight thermopiles.

5. The enclosed spaces fire detection system of claim 1, wherein each of the thermopiles has a field of view (FOV) range of 90°×90°.

6. The enclosed spaces fire detection system of claim 1, wherein the antireflective layer on the thermopile lens is configured to block infrared radiance in a second range.

7. The enclosed spaces fire detection system of claim 1, wherein the at least one infrared device comprises a plurality of infrared imaging cameras arranged around a periphery of the housing so as to be configured to detect a fire at any of a plurality of sides of the enclosed spaces fire detection system.

8. The enclosed spaces fire detection system of claim 1, further comprising at least one visible camera configured to obtain an image of an area around the enclosed spaces fire detection system in response to an output from the at least one infrared imaging camera.

9. The enclosed spaces fire detection system of claim 8,
wherein the at least one infrared imaging device comprises a plurality of infrared cameras arranged around a periphery of the housing so as to be configured to detect a fire at any of a plurality of sides of the enclosed spaces fire detection system,
wherein the at least one visible camera comprises a plurality of cameras arranged around the periphery of the housing so as to be configured to obtain an image at any of the plurality of sides of the enclosed spaces fire detection system, and
wherein each of the plurality of infrared imaging cameras and the plurality of cameras is arranged as a fixed array.

10. The enclosed spaces fire detection system of claim 1, wherein a shape of the housing is adjustable.

11. The enclosed spaces fire detection system of claim 1, wherein the housing is reconfigurable in height.

12. The enclosed spaces fire detection system of claim 1, wherein the enclosed spaces fire detection system is configured to transmit a signal to a user, await acknowledgment, and send another signal if acknowledgment is not received.

13. The enclosed spaces fire detection system of claim 1, wherein the enclosed spaces fire detection system is configured to capture an image if heat is detected by the at least one infrared imaging camera.
